(19) United States
(12) Patent Application Publication
(10) Pub. No.: US 2009/0243957 A1
(43) Pub. Date: Oct. 1, 2009

(54) SYSTEMS AND METHODS FOR INFORMATION VISUALIZATION IN MULTI-DISPLAY ENVIRONMENTS

(75) Inventors: Tao Ni, Christiansburg, VA (US); Patrick Chiu, Menlo Park, CA (US); Don Kimber, Foster City, CA (US)

Correspondence Address: SUGHRUE MION, PLLC, 2100 PENNSYLVANIA AVENUE, N.W., SUITE 800, WASHINGTON, DC, 20037, US

(73) Assignee: FUJI XEROX, CO., LTD., Tokyo (JP)

(21) Appl. No.: 12/055,239

(22) Filed: Mar. 25, 2008

(51) Int. Cl. G09G 5/00

(52) U.S. Cl. 345/1.1

(57) ABSTRACT

A system for visualizing information in multi-display environments (“MDEs”) using spatial and perspective-aware visualization techniques. In one implementation, the position of each display in a three-dimensional MDE is determined relative to the other displays. Graphical decoration objects and link paths are then used to help visualize relatedness and continuity between graphical data objects and graphical node-link objects on different displays. Three-dimensional decoration objects and link paths are also constructed to visualize interrelationships between data objects on displays that are not on the same plane. The visualization techniques can also be integrated with mobile displays using location sensing technology to dynamically adjust the decoration objects. Additionally, user tracking systems will dynamically adjust the decoration objects based on user perspective. The visualization techniques are applicable to physical, virtual or mixed physical-virtual environments.

### BACKGROUND OF THE INVENTION

1. Field of the Invention

The present invention generally relates to systems and methods for information visualization in a multi-display environment (“MDE”). More specifically, the invention relates to the use of decoration objects to help visualize relatedness and continuity between data objects on different displays in an MDE.

2. Background of the Invention

As information displays become ubiquitous, an important challenge is finding ways to visualize and interact with information in a multi-display environment (“MDE”). The environment or room may contain displays of various sizes: wall displays, table displays, notebook displays, handheld displays, etc. The displays may also be fixed in the environment like a wall display, or mobile like a notebook display.

Another type of MDE is a three-dimensional (“3D”) virtual world that contains virtual displays. For example, a “team room” in a 3D virtual world can be used to share documents and data. Platforms that can support such MDEs are Sun Virtual Workplace MPK20 Sun Virtual Workplace MPK20 (Sun Microsystems, Santa Clara, Calif.; http://research.sun.com/projects/mc/mpk20html (link visited Aug. 29, 2007)), or the popular Second Life (Linden Research, Inc., San Francisco, Calif.; http://secondlife.com (link visited Aug. 29, 2007)).

Furthermore, a MDE can be a mixed physical-virtual 3D environment. An example is a meeting room with a large wall display showing a virtual world, and with other physical displays in the room showing documents and data.

In terms of how people make use of MDEs, we first consider some of the ways people use traditional non-electronic large work surfaces. A common use for large surfaces with low-tech materials like Post-it notes or printed pictures is to tack them onto the walls, tables, and cork boards of a room. These physical paper-based objects can be moved around and organized into meaningful groups. This process can be used for data exploration and sense-making, or for communicating and story-telling with the objects through arrangements and juxtapositions. This basic paradigm can be used for simple applications like organizing notes for projects or putting together photos from related events. Another application is brainstorming, which can involve a single user or multiple users working collaboratively. More sophisticated applications in design and business domains include well-known work processes such as Affinity Diagrams in the U.S. and Europe (Beyer, B., Holtzblatt, K. (1998). Contextual Design: Defining Customer-Centered Systems, Morgan Kaufmann Publishers Inc., San Francisco, Calif., 1997), and the KJ-Method in Japan (Scupin, R. (1997). The KJ Method: A Technique for Analyzing Data Derived from Japanese Ethnology. Human Organization, 56(2): 233-237 (1997)).

Another common type of graphical structures on large displays and whiteboards are links and node-link diagrams. Links can be used to denote relations between graphical objects. Links can also be drawn between physical objects attached to a display surface; an example is the Designers' Outpost, which has been studied for scenarios in Web site design. Klemmer, S. R., Newman, M. W., Farrell, R., Bilezikjian, M., Landay, J. A. (2001). The Designers' Outpost: A tangible interface for collaborative Web site design. Proceedings of UIST '01, pp. 1-10. Node-link diagrams are widely used in a variety of ways like flow charts and organization charts. There are also more sophisticated linked diagram structures such as UML diagrams for software design. Rumbaugh, J., Jacobson, I., and Booch, G. (2004). Unified Modeling Language Reference Manual (2nd Ed.), Addison-Wesley.

These applications can be supported in a multi-display environment with virtual Post-its and pictures. While the benefits of manipulating paper objects (“tangible interaction”) due to familiarity and physical affordances cannot be overlooked, an electronic version has advantages such as being able to save and share states easily, support versioning, and allow a room to switch among multiple persistent projects.

With virtual documents and data objects, innovative techniques for information visualization and interaction can be developed. One example previously developed for a single large display is helping users to visually identify related data objects and groups by implicit brushing and target snapping, which paints arrow decorations on the data objects based on automatic computation of relevance between the data objects and groups. Sun, X., Chiu, P., Huang, J., Back, M., Polak, W. (2006). Implicit brushing and target snapping: data exploration and sense-making on large displays. Proceedings of AVI '06, Short Paper, pp. 258-261. On large displays where drag-and-drop is problematic, this technique can also help the user move a data object (with animation) across the display to a related group; the user performs this action by clicking on the arrow decoration pointing to the desired target group.

For link graphical structures, visualization techniques have been developed for multiple displays. For example, links can be drawn under the seams between displays (crossing through as few seams as possible) and nodes can be moved off the seams. Mackinlay, J. D., Heer, J. (2004). Wideband Displays: Mitigating multiple monitor seams. CHI '04 Extended Abstracts, pp. 1521-1524.

In both kinds of applications described above, in which the basic graphical objects of interest are arrows and links, difficulties arise when there are multiples displays. This is especially true when the displays are not on the same plane. Another issue is how to deal with mobile displays that are part of the MDE. Thus, it is desired to develop methods for visualizing graphical objects in a MDE.

### SUMMARY OF THE INVENTION

The present invention relates to systems and methods for visualizing information in MDEs using spatial and perspective-aware visualization techniques. In one embodiment, decoration objects are used to help visualize relatedness and continuity between data objects on different displays in a three-dimensional space. Three-dimensional decoration objects and link paths are also constructed in MDEs where the displays are not on the same plane. The visualization techniques can also be integrated with location sensing technology to provide real-time position information for mobile displays. The visualization techniques are also applicable to physical, virtual or mixed physical-virtual environments.

In accordance with one aspect of the inventive methodology, there is provided a system for visualizing information in a multi-display environment, the system including a multi-display environment (“MDE”) including multiple displays arranged in different planes within a three dimensional (“3D”) space, the multiple displays configured to display multiple graphical data objects arranged on the MDE; a coordinate determination module operable to determine a position of each of the multiple displays and to use the determined position of each of the multiple displays to calculate a position of each of the multiple graphical data objects; and a placement module for placing multiple graphical decoration objects with direction-indicating properties on the multiple graphical data objects, the multiple graphical decoration objects illustrating interrelationships of the graphical data objects in the multiple displays.

In another aspect of the invention, the MDE is a physical environment.

In a further aspect of the invention, the MDE is a virtual environment.

In still another aspect of the invention, the MDE is a mixed physical-virtual environment.

In a yet further aspect of the invention, the graphical decoration objects include 3D shapes.

In another aspect of the invention, the 3D shapes include arrows.

In a further aspect of the invention, at least one of the multiple displays is a mobile display.

In still another aspect of the invention, the system further includes a tracking module operable to track a location of the at least one mobile display.

In a yet further aspect of the invention, the system further includes a positioning module operable to position the graphical decoration objects in relation to a perspective of a user viewing the MDE.

In another aspect of the invention, the system further includes a user tracking module operable to track the position of the user relative to the MDE.

In a further aspect of the invention, the interrelationships of the graphical data objects are determined based on the similarity of text, metadata or image features of the graphical data objects.

In still another aspect of the invention, a graphical data object is interrelated with a cluster of graphical data objects and wherein the cluster is detected by a clustering algorithm.

In a further aspect of the invention, a system for visualizing information in a multi-display environment, the system includes a multi-display environment (“MDE”) including multiple displays arranged in different planes within a three dimensional (“3D”) space, the multiple displays operable to display a plurality of graphical node-link objects arranged on the MDE; a coordinate determination module operable to determine a position of each of the multiple displays and to use the determined position of each of the multiple displays to calculate a position of each of the multiple graphical data objects; and a placement module for placing a multiple graphical connector objects with direction-indicating properties on the multiple graphical node-link objects at a point where a link object extends beyond an edge of one of the multiple displays, the multiple graphical connector objects illustrating interrelationships of the graphical data objects in the multiple displays.

In another aspect of the invention, a pair of graphical connector objects include distinctive visual matching properties.

In another aspect of the invention, the graphical decoration objects include 3D shapes.

In a still further aspect of the invention, a method for visualizing information in a multi-display environment includes displaying multiple graphical data objects on multiple displays in a multi-display environment (“MDE”), wherein the multiple displays are arranged in different planes within a three dimensional (“3D”) space; determining a position of each of the multiple displays and a position of each of the multiple graphical data objects in the MDE in relation to the arrangement of the multiple displays; and placing at least one graphical decoration object on at least one of the multiple graphical data objects, the graphical decoration objects each having a direction-indicating property operable to illustrate interrelationships of the multiple graphical data objects on the multiple displays.

In a further aspect of the invention, the method includes selecting 3D shapes as the graphical decoration objects.

In a further aspect of the invention, a method for visualizing information in a multi-display environment, the method includes displaying multiple graphical node-link objects on multiple displays in a multi-display environment (“MDE”), wherein the multiple displays are arranged in different planes within a three dimensional (“3D”) space; determining a position of each of the multiple displays and a position of each of the multiple graphical node-link objects in the MDE in relation to the arrangement of the multiple displays; and placing at least one graphical connector object on at least one of the multiple graphical data objects at a point where a link object extends beyond an edge of one of the multiple displays, the graphical connector objects each having a direction-indicating property operable to illustrate the interrelationships of the multiple graphical node-link objects on the multiple displays.

In a further aspect of the invention, the method includes providing distinctive visual matching properties on the graphical connector objects.

In a further aspect of the invention, the method includes selecting 3D shapes as the graphical decoration objects.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1A depicts a graphic illustration of a physical multi-display environment (“MDE”) that includes multiple displays in a three-dimensional (“3D”) space, according to one embodiment of the invention;

FIG. 1B depicts a photographic illustration of the physical MDE that includes multiple displays in a 3D space, according to one embodiment of the invention;

FIG. 1C depicts a graphic illustration of a physical MDE with a physical coordinate determination system to determine the position of each display in the 3D space and the position of objects within each display;

FIG. 2 depicts a graphical illustration of a virtual MDE that includes multiple virtual displays in a virtual 3D space, according to one embodiment of the invention;

FIG. 3 depicts a graphical user interface of a multiple graphical data objects that would appear on a display in an MDE, including a graphical decoration object, according to one embodiment of the invention;

FIG. 4 depicts a graphical user interface of a multiple clusters of graphical data objects that would appear on a display in an MDE, according to one embodiment of the invention;

FIG. 5A depicts an graphical illustration of 3D arrows that represent one embodiment of a graphical decoration object;

FIG. 5B depicts a graphical illustration of an MDE in a 3D environment incorporating the 3D arrows for relating graphical data objects on other displays that are on different planes;

FIG. 6 depicts an graphical illustration of link connectors for connecting graphical data objects in an MDE, according to one embodiment of the invention;

FIG. 7 depicts an graphical illustration of a 3D link path constructed between two node-link objects on two separate displays in an MDE, according to one embodiment of the invention; and

FIG. 8 illustrates an exemplary embodiment of a computer platform upon which the inventive system may be implemented.

### DETAILED DESCRIPTION OF THE INVENTION

In the following detailed description, reference will be made to the accompanying drawing(s), in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

The present invention relates to systems and methods for visualizing information in multi-display environments (“MDEs”) using spatial and perspective-aware visualization techniques. In one embodiment, the position of each display in a three-dimensional MDE is determined relative to the other displays. Graphical decoration objects and link paths are then used to help visualize relatedness and continuity between graphical data objects and graphical node-link objects on different displays. Three-dimensional decoration objects and link paths are also constructed to visualize interrelationships between data objects on displays that are not on the same plane. The visualization techniques can also be integrated with mobile displays using location sensing technology to dynamically adjust the decoration objects. Additionally, user tracking systems will dynamically adjust the decoration objects based on user perspective. The visualization techniques are applicable to physical, virtual or mixed physical-virtual environments.

A physical multi-display environment can be easily and inexpensively put together using off the shelf products. The wall displays can be large flat panels (e.g. LCD, plasma, etc.) or projection displays (front or rear projected). These large displays can be driven by PCs. Mobile displays can be Tablet PCs, laptops, handheld devices, etc.

All the displays can be connected to a local area network with wired or wireless connections. The computers that drive the displays communicate with one another on the network to coordinate the visualization and interaction. The visualization applications on the displays can communicate with each other over the network using software such as Java Remote Method Indication (“Java RMI”) or XML-Remote Procedure Call (“XML-RPC”). A more sophisticated option is to use a message broker like Apache ActiveMQ (The Apache Software Foundation, http://activemq.apache.org). The embodiment described herein uses software similar to ActiveMQ.

### MDE Coordinate Systems

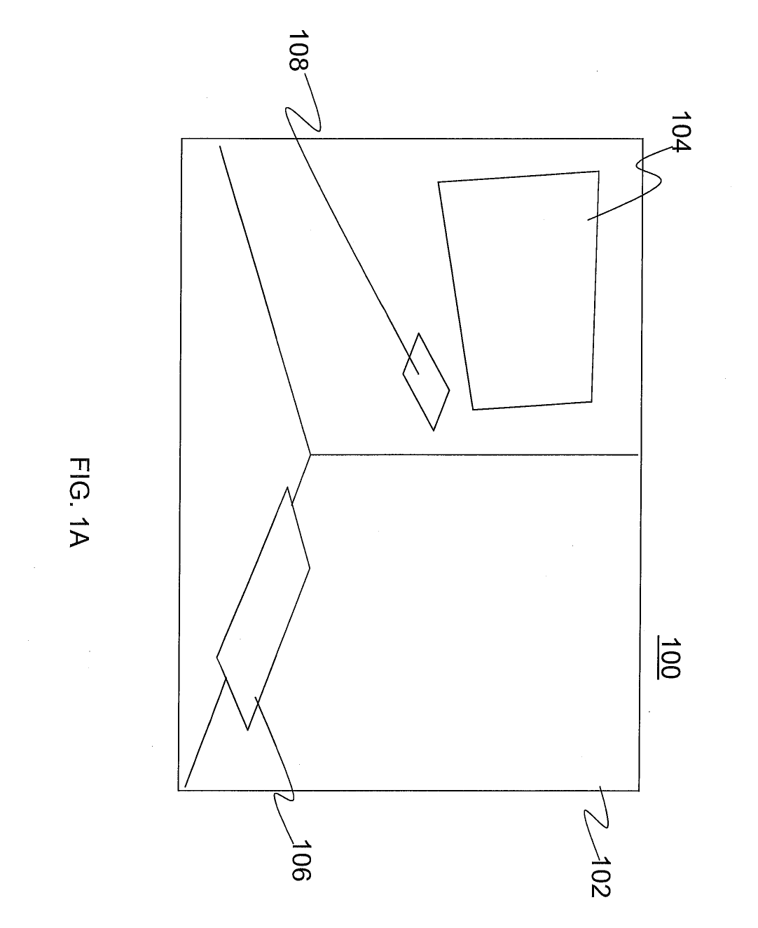

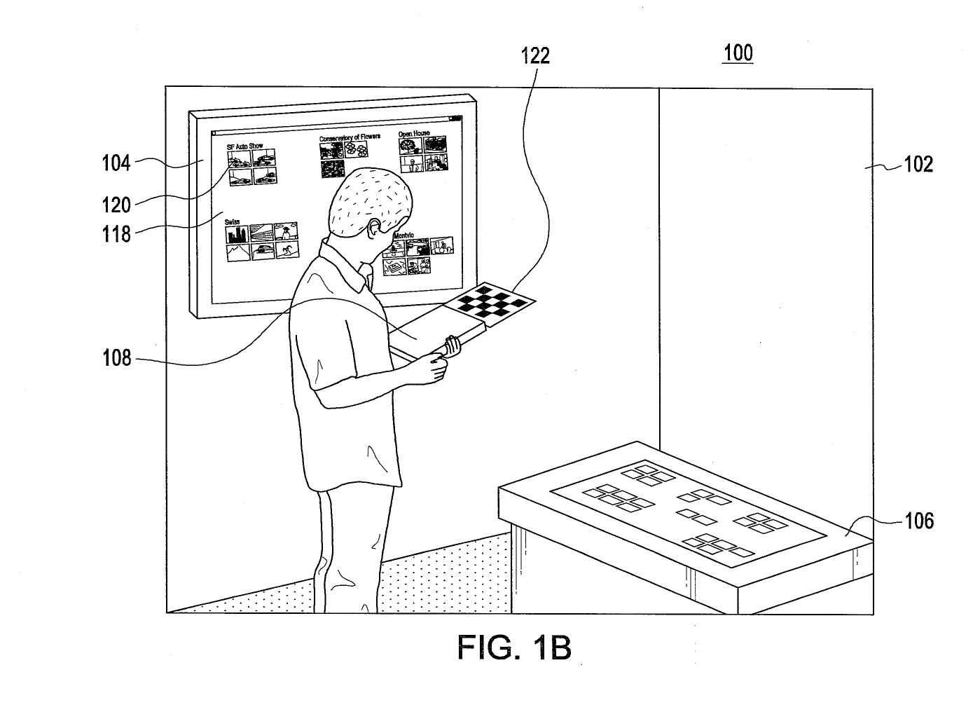

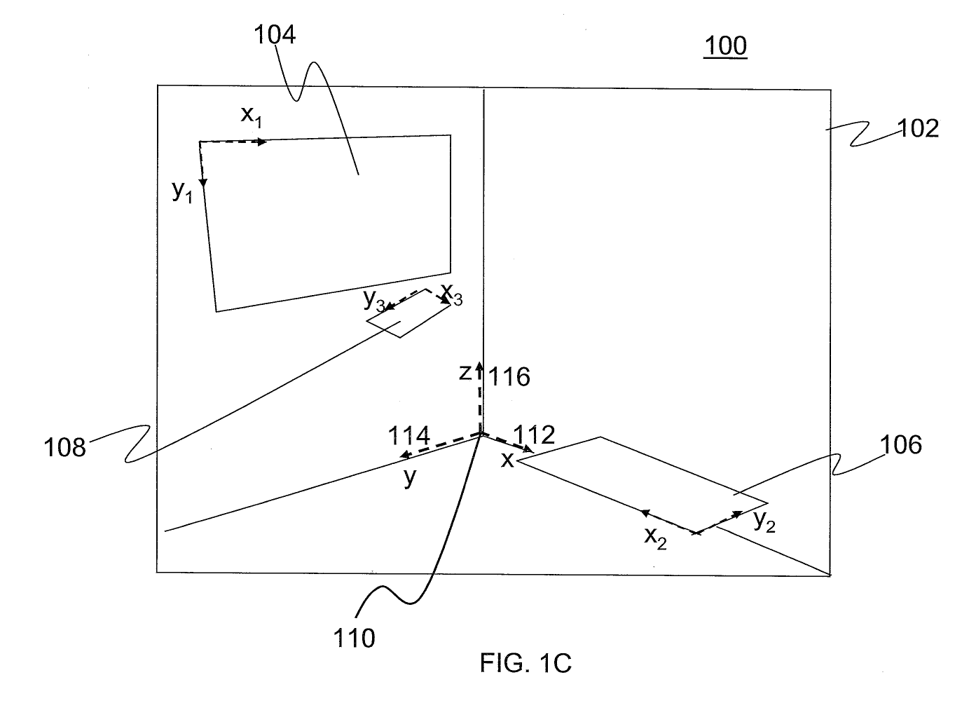

In order to interrelate graphical data objects in an MDE, the displays of the MDE must be spatially aware of each other. To accomplish this in a physical MDE in three-dimensional (“3D”) space, there is a physical coordinate determination module. A graphic illustration of a physical MDE 100 in a 3D space is depicted in FIG. 1A, while a corresponding photographic depiction of the physical MDE 100 in 3D space is shown in FIG. 1B. FIG. 1C is a graphic illustration of the physical MDE 100 showing a coordinate system for determining the position of the various display and other objects in the 3D space. A room 102 includes a wall display 104, table display 106 and mobile display 108. For example, one corner of the room can be assigned the origin point 110, and the x, y, and z axes (112, 114, 116, respectively) can be assigned directions along different walls or floors.

Each display 102, 104, 106 has a position (x, y, z) in physical space, and a normal vector through the display surface 118. Rendered on the display surface is a canvas that has its own 2D coordinate system. As shown in FIG. 1C, wall display 104 has planes x1 and y1, table display 106 has planes x2 and y2, and mobile display 108 has planes x3 and y3 to determine the position of objects within each display. The canvas in turn is a projection of a 3D coordinate space that defines the 3D world of that display. Thus, given a graphical data object 120 on the canvas or the display's 3D world, its real world physical position can be determined by the mapping of the basis vectors of the display's 3D world to the physical world.

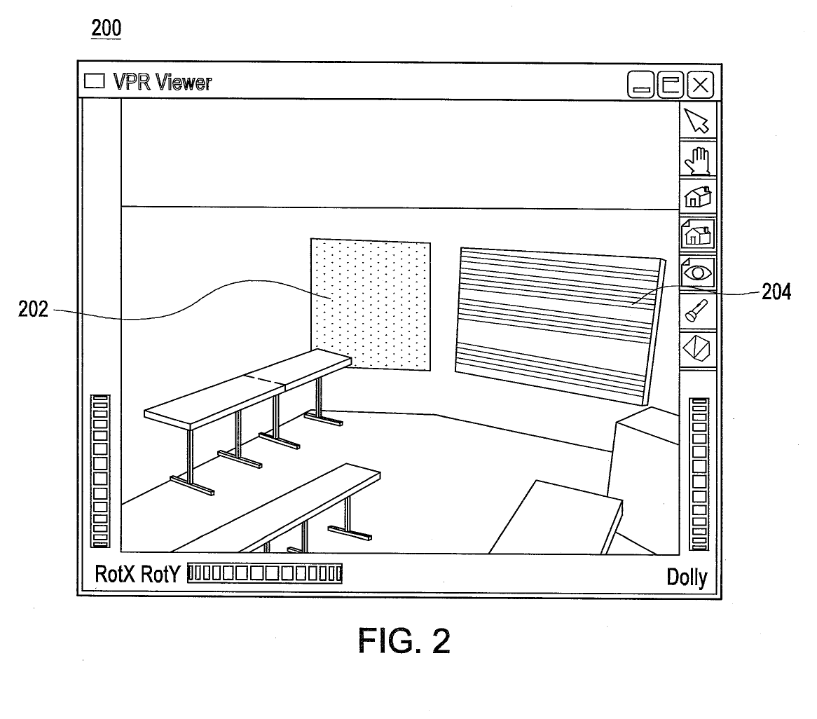

For virtual or mixed physical-virtual MDEs, the virtual part can be built using platforms such as Sun Virtual Workplace MPK20 (Sun Microsystems, Santa Clara, Calif.; http://research.sun.com/projects/mc/mpk20.html (link visited Aug. 29, 2007)), or Second Life (Linden Research, Inc., San Francisco, Calif.; http://secondlife.com (link visited Aug. 29, 2007)). The virtual displays are objects in the virtual world that are modeled after real world displays. A research prototype of a virtual world 200 is shown in FIG. 2, including virtual wall displays 202, 204.

In a pure virtual 3D MDE, such as that illustrated in FIG. 2, the above-mentioned situation is trivial because there is a single coordinate system. In a mixed physical-virtual MDE, the interface or intersection between a virtual MDE component and the physical world is a display surface. By using this display's location in the physical world, the location of the objects inside the virtual component can be determined with respect to the physical world coordinate system.

### Graphical Decoration Objects

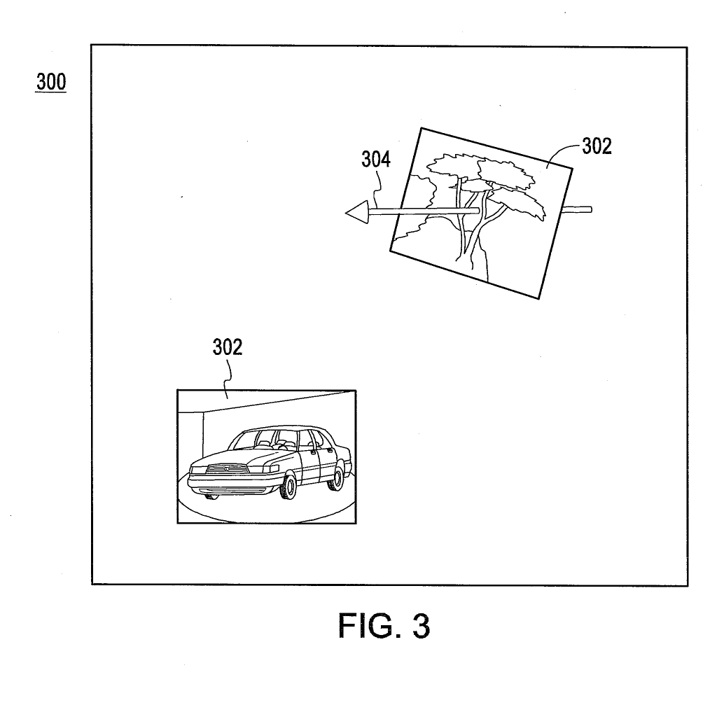

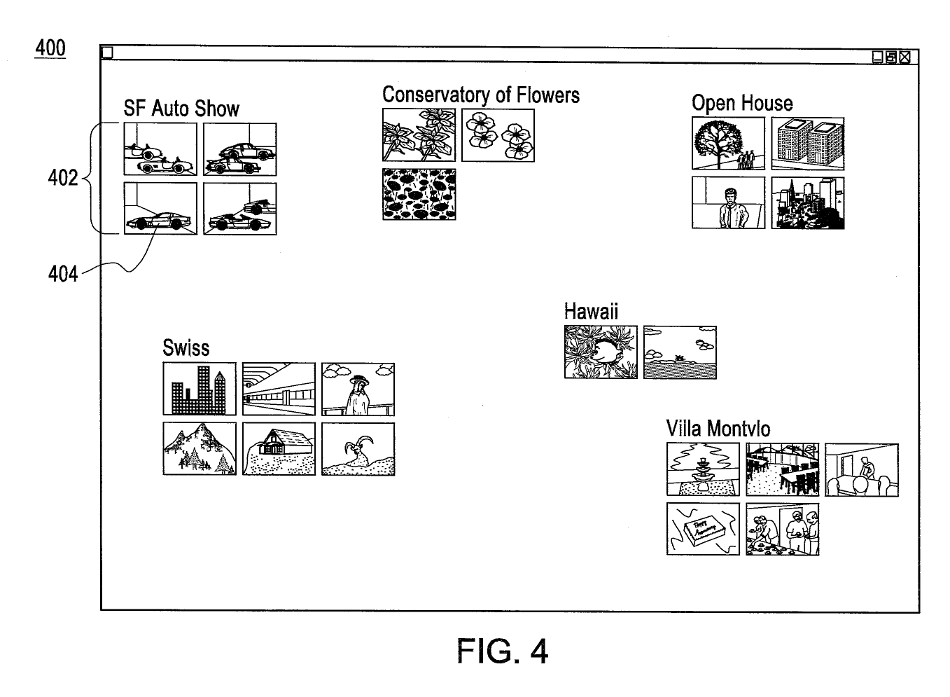

As illustrated in FIG. 3, a graphical user interface 300 depicts a plurality of graphical data objects 302 such as photographs, documents, icons or any type of computer-generated object. In the non-limiting embodiment illustrated in FIG. 3, the graphical data objects 302 are photographs. A user may want to view a collection of photographs on different displays in an MDE and organize them into groups based on the interrelationships of the photographs. For example, the graphical user interface 400 in FIG. 4 depicts a plurality of clusters 402 of photographs 404. The user may implement software to automatically determine the relationships of the photographs based on text, image features or metadata, or the user may manually relate the photographs. In one aspect of the embodiment illustrated in FIG. 4, the clusters 402 of photographs 404 may be determined using a clustering algorithm.

Decoration objects are then arranged on the photographs using a placement module in order to visually illustrate the interrelationship with other photographs on other displays. The decoration objects have direction-indicating properties for illustrating the interrelationships of the graphical data objects in the plurality of displays. In FIG. 3, the decoration object is an arrow 304 centered on the photograph 302 that points to another related photograph on another display. One skilled in the art will appreciate that the direction-indicating properties are not limited to an arrow but may encompass a number of properties such as color, texture, shape or labels in order to depict the interrelationships with other graphical data objects on other displays.

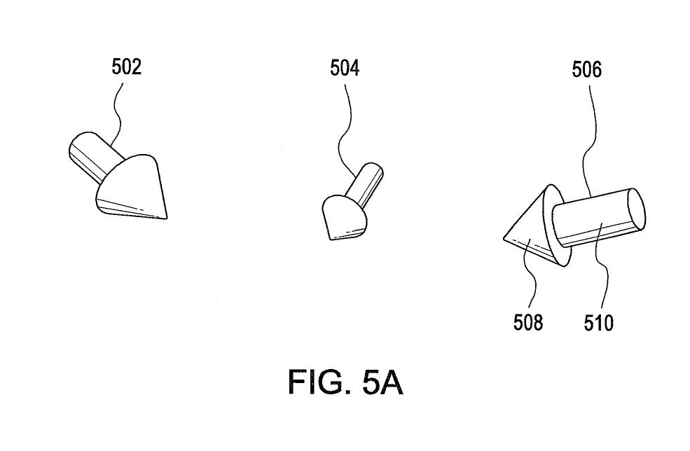

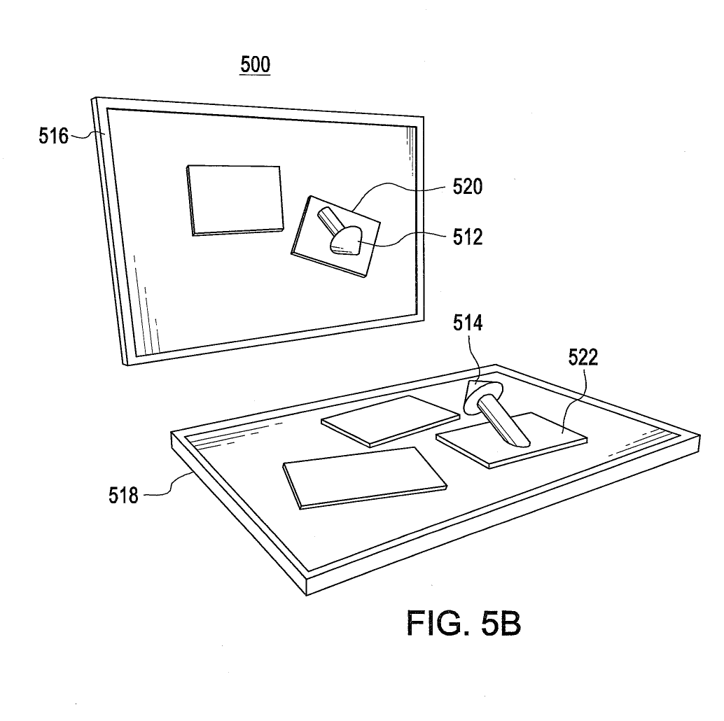

In one embodiment, the decoration objects for indicating relatedness between objects and groups are 3D shapes that provide a more accurate sense of the direction that the decoration object is pointing. FIG. 5A depicts 3D arrows 502, 504, 506 that all point in different directions. The 3D shape of the arrows 502, 504, 506 more accurately depict the direction-indicating properties of the decoration objects, which is especially useful in an MDE in a 3D space such as that depicted in FIG. 1.

The 3D arrows 502, 504, 506 can be constructed by combining a cone 508 with a cylinder 510. We describe the simplest form, although more complex arrows can be constructed and customized for specific applications. FIG. 5B a graphical representation of 3D arrows 512, 514 in a MDE 500. A first display 516 is positioned perpendicular to a second display 518, with a first graphical data object 520 in the first display and a second graphical data object 522 in the second display. In this embodiment, the graphical data objects 520, 522 are related, such that 3D arrow 512 will point from the first graphical data object 520 to the second graphical data object 522, while F3D arrow 514 will point from the second graphical data object 522 to the first graphical data object 520. The 3D shapes therefore provide a user in the physical MDE a true sense of directional relatedness between objects on different displays in different planes.

### Link Connectors

In addition to arrows, links between graphical data objects can be shown to create a more visible correlation between related graphical data objects. In a MDE, direct links across displays is a challenge. Graphical connector objects such as link connectors or link paths can be constructed between graphical node-link objects in MDEs in order to illustrate direction-indicating properties and help a user visualize the links across displays.

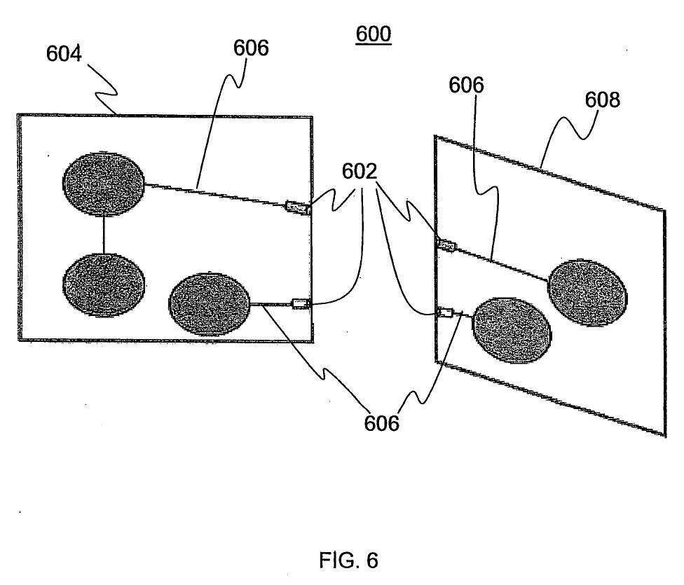

In one embodiment of a MDE 600, as depicted in FIG. 6, decoration objects for indicating the continuation of link paths are link connectors 602. Link connectors 602 are positioned at the edge of a first display 604 where the link 606 jumps to a second display 608. 3D link connectors can be constructed by using cylinders or tapered cylinders to more accurately depict direction-indicating properties similar to the arrows in FIG. 5. For directed links, the connectors can have a direction-indicating property (e.g. arrow-shaped connectors). Visual properties such as color, texture, and labels can be used to indicate matching pairs of connectors.

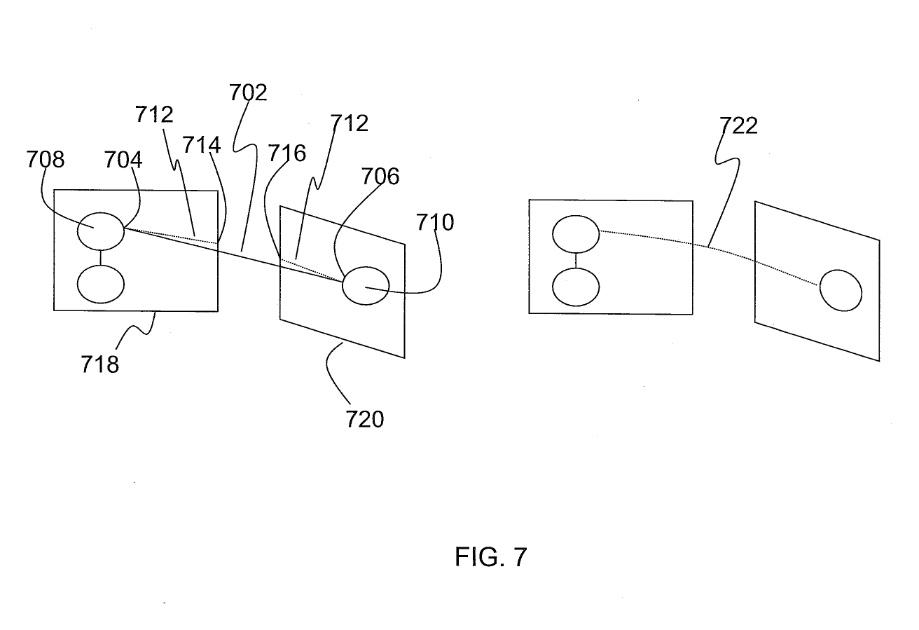

The 3D path of a link can be constructed in various ways, as illustrated in MDE in FIG. 7. One method is to take the line segment 702 that goes through the connection points 704, 706 of the two graphical node-link objects 708, 710 and create a projected line segment 712 onto the displays. The points 714, 716 where the projected lines 712 intersect the edge of the displays 718, 720 is noted. Though these four points—two graphical node-link connection points 704, 706 and two display intersection points 714, 716—a curve 722 can be constructed. The curve 722 provides a smooth path that helps the user infer the missing portion between the displays by mentally extrapolating the curved pieces that connect together. Cubic splines or other curve interpolation methods may be used to calculate the curve.

Integration with Local Sensing Systems

In order to incorporate the use of mobile displays in an MDE, location sensing systems can be implemented to track the location of the mobile displays and dynamically adjust the decoration objects to reflect the movement of the mobile display. A system of a physical MDE that has location sensing is shown in FIG. 1.

For the tracking system, commercial products may be used (Vicon Motion Systems. http://www.vicon.com (link visited Aug. 30, 2007)). For the system of FIG. 1, a camera is placed overhead (not shown) and looks down on the 3D space. A checkerboard tracker 122 is connected with the mobile display 108, and the camera captures images of the movement of the checkerboard 122.

The pose of the checkerboard 122 is determined using functions in the Intel OpenCV software library tool kit (Intel Corp., Santa Clara, Calif.; http://www.intel.com/technology/computing/opencv (link visited Aug. 30, 2007)). First the corners of the checkerboard 122 are found with sub-pixel accuracy, and then using the correspondences between these points and the known positions of the points on the checkerboard 122, the transform between the camera and coordinate systems of the physical MDE 100 can be determined. Once determined, the movement of the mobile display 108 is translated into movement of the various graphical decoration objects on the plurality of displays 104, 106, 108 in the MDE 100.

### Perspective Aware Rendering

In some scenarios it may be appropriate to render the graphical decoration objects in perspective with respect to the user's point of view. This requires tracking the user's head or eye gaze. In one embodiment, the user wears a headband with a sensor object that is tracked using, for example, the Vicon Motion System mentioned above. Note that this is not appropriate for multi-user applications where there are multiple perspectives.

### Computer Implementation

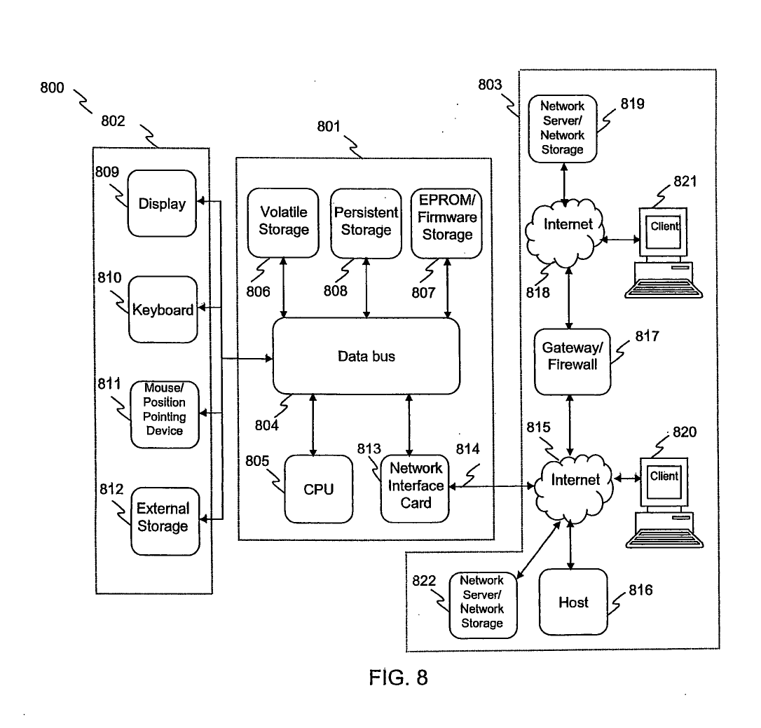

FIG. 8 is a block diagram that illustrates an embodiment of a computer/server system 800 upon which an embodiment of the inventive methodology may be implemented. The system 800 includes a computer/server platform 801, peripheral devices 802 and network resources 803.

The computer platform 801 may include a data bus 804 or other communication mechanism for communicating information across and among various parts of the computer platform 801, and a processor 805 coupled with bus 801 for processing information and performing other computational and control tasks. Computer platform 801 also includes a volatile storage 806, such as a random access memory (RAM) or other dynamic storage device, coupled to bus 804 for storing various information as well as instructions to be executed by processor 805. The volatile storage 806 also may be used for storing temporary variables or other intermediate information during execution of instructions by processor 805. Computer platform 801 may further include a read only memory (ROM or EPROM) 807 or other static storage device coupled to bus 804 for storing static information and instructions for processor 805, such as basic input-output system (BIOS), as well as various system configuration parameters. A persistent storage device 808, such as a magnetic disk, optical disk, or solid-state flash memory device is provided and coupled to bus 801 for storing information and instructions.

Computer platform 801 may be coupled via bus 804 to a display 809, such as a cathode ray tube (CRT), plasma display, or a liquid crystal display (LCD), for displaying information to a system administrator or user of the computer platform 801. An input device 820, including alphanumeric and other keys, is coupled to bus 801 for communicating information and command selections to processor 805. Another type of user input device is cursor control device 811, such as a mouse, a trackball, or cursor direction keys for communicating direction information and command selections to processor 804 and for controlling cursor movement on display 809. This input device typically has two degrees of freedom in two axes, a first axis (e.g., x) and a second axis (e.g., y), that allows the device to specify positions in a plane.

An external storage device 812 may be connected to the computer platform 801 via bus 804 to provide an extra or removable storage capacity for the computer platform 801. In an embodiment of the computer system 800, the external removable storage device 812 may be used to facilitate exchange of data with other computer systems.

The invention is related to the use of computer system 800 for implementing the techniques described herein. In an embodiment, the inventive system may reside on a machine such as computer platform 801. According to one embodiment of the invention, the techniques described herein are performed by computer system 800 in response to processor 805 executing one or more sequences of one or more instructions contained in the volatile memory 806. Such instructions may be read into volatile memory 806 from another computer-readable medium, such as persistent storage device 808. Execution of the sequences of instructions contained in the volatile memory 806 causes processor 805 to perform the process steps described herein. In alternative embodiments, hard-wired circuitry may be used in place of or in combination with software instructions to implement the invention. Thus, embodiments of the invention are not limited to any, specific combination of hardware circuitry and software.

The term “computer-readable medium” as used herein refers to any medium that participates in providing instructions to processor 805 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 808. Volatile media includes dynamic memory, such as volatile storage 806. Transmission media includes coaxial cables, copper wire and fiber optics, including the wires that comprise data bus 804. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 805 for execution. For example, the instructions may initially be carried on a magnetic disk from a remote computer. Alternatively, a remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on the data bus 804. The bus 804 carries the data to the volatile storage 806, from which processor 805 retrieves and executes the instructions. The instructions received by the volatile memory 806 may optionally be stored on persistent storage device 808 either before or after execution by processor 805. The instructions may also be downloaded into the computer platform 801 via Internet using a variety of network data communication protocols well known in the art.

The computer platform 801 also includes a communication interface, such as network interface card 813 coupled to the data bus 804. Communication interface 813 provides a two-way data communication coupling to a network link 814 that is connected to a local network 815. For example, communication interface 813 may be an integrated services digital network (ISDN) card or a modem to provide a data communication connection to a corresponding type of telephone line. As another example, communication interface 813 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 813 sends and receives electrical, electromagnetic or optical signals that carry digital data streams representing various-types of information.

Network link 813 typically provides data communication through one or more networks to other network resources. For example, network link 814 may provide a connection through local network 815 to a host computer 816, or a network storage/server 817. Additionally or alternatively, the network link 813 may connect through gateway/firewall 817 to the wide-area or global network 818, such as an Internet. Thus, the computer platform 801 can access network resources located anywhere on the Internet 818, such as a remote network storage/server 819. On the other hand, the computer platform 801 may also be accessed by clients located anywhere on the local area network 815 and/or the Internet 818. The network clients 820 and 821 may themselves be implemented based on the computer platform similar to the platform 801.

Local network 815 and the Internet 818 both use electrical, electromagnetic or optical signals that carry digital data streams. The signals through the various networks and the signals on network link 814 and through communication interface 813, which carry the digital data to and from computer platform 801, are exemplary forms of carrier waves transporting the information.

Computer platform 801 can send messages and receive data, including program code, through the variety of network(s) including Internet 818 and LAN 815, network link 814 and communication interface 813. In the Internet example, when the system 801 acts as a network server, it might transmit a requested code or data for an application program running on client(s) 820 and/or 821 through Internet 818, gateway/firewall 817, local area network 815 and communication interface 813. Similarly, it may receive code from other network resources.

The received code may be executed by processor 805 as it is received, and/or stored in persistent or volatile storage devices 808 and 806, respectively, or other non-volatile storage for later execution. In this manner, computer system 801 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Although various representative embodiments of this invention have been described above with a certain degree of particularity, those skilled in the art could make numerous alterations to the disclosed embodiments without departing from the spirit or scope of the inventive subject matter set forth in the specification and claims. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. Also, various aspects and/or components of the described embodiments may be used singly or in any combination in the system for visualizing information in a multi-display environment. It is intended that all matter contained in the above description or shown in the accompanying drawings shall be interpreted as illustrative only and not limiting.

What is claimed is:

1. A system for visualizing information in a multi-display environment, the system comprising:
a multi-display environment (“MDE”) comprising a plurality of displays arranged in different planes within a three dimensional (“3D”) space, the plurality of displays operable to display a plurality of graphical data objects arranged on the MDE;
a coordinate determination module operable to determine a position of each of the plurality of displays and to use the determined position of each of the plurality of displays to calculate a position of each of the plurality of graphical data objects; and
a placement module for placing a plurality of graphical decoration objects with direction-indicating properties on the plurality of graphical data objects, the plurality of graphical decoration objects illustrating interrelationships of the graphical data objects in the plurality of displays.

2. The system of claim 1, wherein the MDE is a physical environment.

3. The system of claim 1, wherein the MDE is a virtual environment.

4. The system of claim 1, wherein the MDE is a mixed physical-virtual environment.

5. The system of claim 1, wherein the graphical decoration objects comprise 3D shapes.

6. The system of claim 5, wherein the 3D shapes comprise arrows.

7. The system of claim 1, wherein at least one of the plurality of displays is a mobile display.

8. The system of claim 7, further comprising a tracking module operable to track a location of the at least one mobile display.

9. The system of claim 1, further comprising a positioning module operable to position the graphical decoration objects in relation to a perspective of a user viewing the MDE.

10. The system of claim 9, further comprising a user tracking module operable to track the position of the user relative to the MDE.

11. The system of claim 1, wherein the interrelationships of the graphical data objects are determined based on the similarity of text, metadata or image features of the graphical data objects.

12. The system of claim 1, wherein a graphical data object is interrelated with a cluster of graphical data objects and wherein the cluster is detected by a clustering algorithm.

13. A system for visualizing information in a multi-display environment, the system comprising:
a multi-display environment (“MDE”) comprising a plurality of displays arranged in different planes within a three dimensional (“3D”) space, the plurality of displays operable to display a plurality of graphical node-link objects arranged on the MDE;
a coordinate determination module operable to determine a position of each of the plurality of displays and to use the determined position of each of the plurality of displays to calculate a position of each of the plurality of graphical data objects; and
a placement module for placing a plurality of graphical connector objects with direction-indicating properties on the plurality of graphical node-link objects at a point where a link object extends beyond an edge of one of the plurality of displays, the plurality of graphical connector objects illustrating interrelationships of the graphical data objects in the plurality of displays.

14. The system of claim 13, wherein a pair of graphical connector objects comprise distinctive visual matching properties.

15. The system of claim 13, wherein the graphical decoration objects comprise 3D shapes.

16. A method for visualizing information in a multi-display environment, the method comprising:
displaying a plurality of graphical data objects on a plurality of displays in a multi-display environment (“MDE”), wherein the plurality of displays are arranged in different planes within a three dimensional (“3D”) space;
determining a position of each of the plurality of displays and a position of each of the plurality of graphical data objects in the MDE in relation to the arrangement of the plurality of displays; and
placing at least one graphical decoration object on at least one of the plurality of graphical data objects, the graphical decoration objects each having a direction-indicating property operable to illustrate interrelationships of the plurality of graphical data objects on the plurality of displays.

17. The method of claim 16, further comprising selecting 3D shapes as the graphical decoration objects.

18. A method for visualizing information in a multi-display environment, the method comprising:
displaying a plurality of graphical node-link objects on a plurality of displays in a multi-display environment (“MDE”), wherein the plurality of displays are arranged in different planes within a three dimensional (“3D”) space;
determining a position of each of the plurality of displays and a position of each of the plurality of graphical node-link objects in the MDE in relation to the arrangement of the plurality of displays; and
placing at least one graphical connector object on at least one of the plurality of graphical data objects at a point where a link object extends beyond an edge of one of the plurality of displays, the graphical connector objects each having a direction-indicating property operable to illustrate the interrelationships of the plurality of graphical node-link objects on the plurality of displays.

19. The method of claim 18, further comprising providing distinctive visual matching properties on the graphical connector objects.

20. The method of claim 18, further comprising selecting 3D shapes as the graphical decoration objects.
